(19) United States
(12) Patent Application Publication
(10) Pub. No.: US 2024/0164590 A1
(43) Pub. Date: May 23, 2024

(54) PORTABLE SANITIZER APPARATUS

(71) Applicant: Dave McCarter, Fairfield, CA (US)

(72) Inventor: Dave McCarter, Fairfield, CA (US)

(21) Appl. No.: 17/239,558

(22) Filed: Apr. 24, 2021

(51) Int. Cl. A47K 1/02; A47K 1/08; B08B 1/40; B08B 7/04

(52) U.S. Cl. CPC A47K 1/02; A47K 1/08; B08B 1/40; B08B 7/04; A47K 2210/00; B08B 2203/007

(57) ABSTRACT

Illustrated views of a structure of the portable sanitizer apparatus for providing hand washing and hand sanitizer facilities for people before entering a building is presented. The portable sanitizer apparatus is useful for providing outside and portable facilities for hand washing and hand sanitizing before entering a building. The portable sanitizer apparatus is further useful for providing one or more stations to allow the sanitizing operation to be automatic and more efficient. A further advantage of the portable sanitizer apparatus is it alleviates the need to use in-building bathroom space or other space to be dedicated to the sanitation process.

### FIELD OF THE INVENTION

This invention relates to sanitization to avoid infectious diseases. More particularly, it relates to a portable sanitizer apparatus to prevent infectious disease dissemination.

### BACKGROUND

A disease is a particular abnormal condition that negatively affects the structure or function of all or part of an organism, and that is not due to any immediate external injury. Diseases are often known to be medical conditions that are associated with specific symptoms and signs. A disease may be caused by external factors such as pathogens or by internal dysfunctions. For example, internal dysfunctions of the immune system can produce a variety of different diseases, including various forms of immunodeficiency, hyper-sensitivity, allergies and autoimmune disorders.

In humans, disease is often used more broadly to refer to any condition that causes pain, dysfunction, distress, social problems, or death to the person afflicted, or similar problems for those in contact with the person. In this broader sense, it sometimes includes injuries, disabilities, disorders, syndromes, infections, isolated symptoms, deviant behaviors, and atypical variations of structure and function, while in other contexts and for other purposes these may be considered distinguishable categories. Diseases can affect people not only physically, but also mentally, as contracting and living with a disease can alter the affected person's perspective on life.

Death due to disease is called death by natural causes. There are four main types of disease: infectious diseases, deficiency diseases, hereditary diseases (including both genetic diseases and non-genetic hereditary diseases), and physiological diseases. Diseases can also be classified in other ways, such as communicable versus non-communicable diseases. The deadliest diseases in humans are coronary artery disease (blood flow obstruction), followed by cerebrovascular disease and lower respiratory infections. In developed countries, the diseases that cause the most sickness overall are neuropsychiatric conditions, such as depression and anxiety.

Many diseases and disorders can be prevented through a variety of means. These include sanitation, proper nutrition, adequate exercise, vaccinations and other self-care and public health measures.

To help stop the spread of diseases, including COVID-19, etc. the government has strongly suggested to sanitize surfaces, wash hands, wear face masks, etc.

Although most businesses, hospitals and other locations have provided sanitizing facilities, hand washing facilities and masks, these places have re-engineered their facilities to now have more of those items available. However, the facilities provided are located inside of the building. This can allow the disease to come into the building and be spread in a number of ways. Further lore, only one patron is able to sanitize and/or wash their hands at a time.

Accordingly, and in light of the foregoing, there is a need for an apparatus to provide sanitization and washing facilities for people's hands prior to entering a building. Furthermore, there is a need for the apparatus to accommodate one or more people simultaneously as well as to be portable.

### BRIEF DESCRIPTION OF THE DRAWINGS

FIGS. 1A 18 are illustrated views of a structure of the portable sanitizer apparatus.

FIGS. 2A-2C are illustrated views of an inside of the portable sanitizer apparatus as shown in FIG. 1A and FIG. 18.

FIG. 3 is an illustrated view of a drain pipe of an inside of the portable sanitizer apparatus shown in FIG. 1A and FIG. 18

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

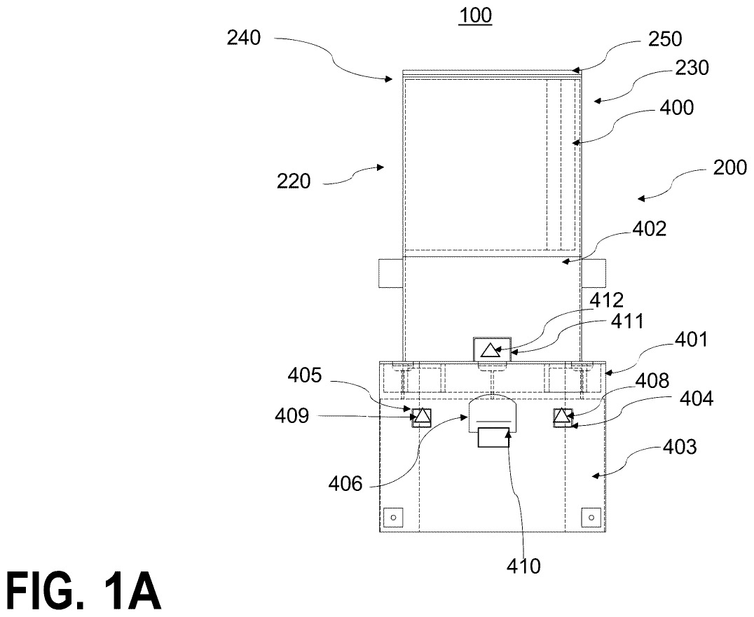

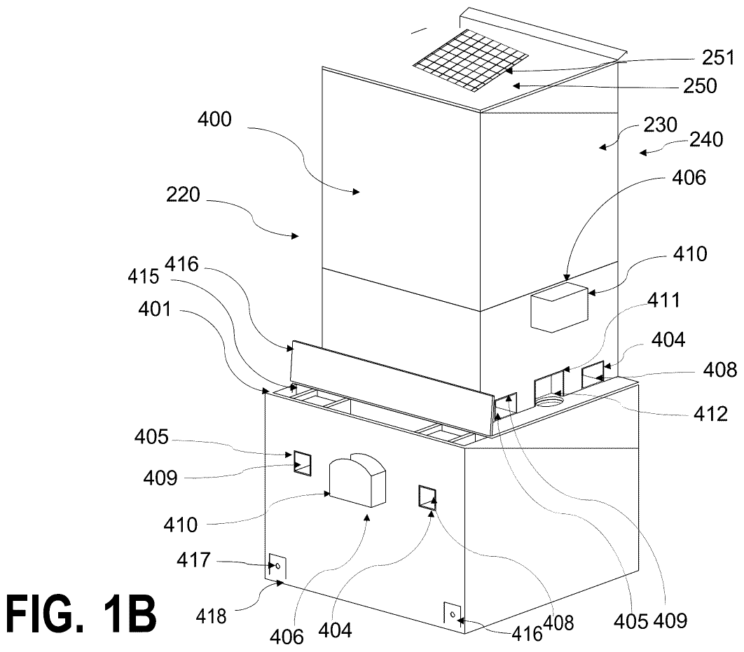

Referring to FIG. 1A and FIG. 1B, illustrated views of a structure 200 of the portable sanitizer apparatus 100 for providing hand washing and hand sanitizer facilities for people before entering a building is presented. The portable sanitizer apparatus 100 is useful for providing outside and portable facilities for hand washing and hand sanitizing before entering a building. The portable sanitizer apparatus 100 is further useful for providing one or more stations to allow the sanitizing operation to be automatic and more efficient. A further advantage of the portable sanitizer apparatus 100 is it alleviates the need to use in-building bathroom space or other space to be dedicated to the sanitation process.

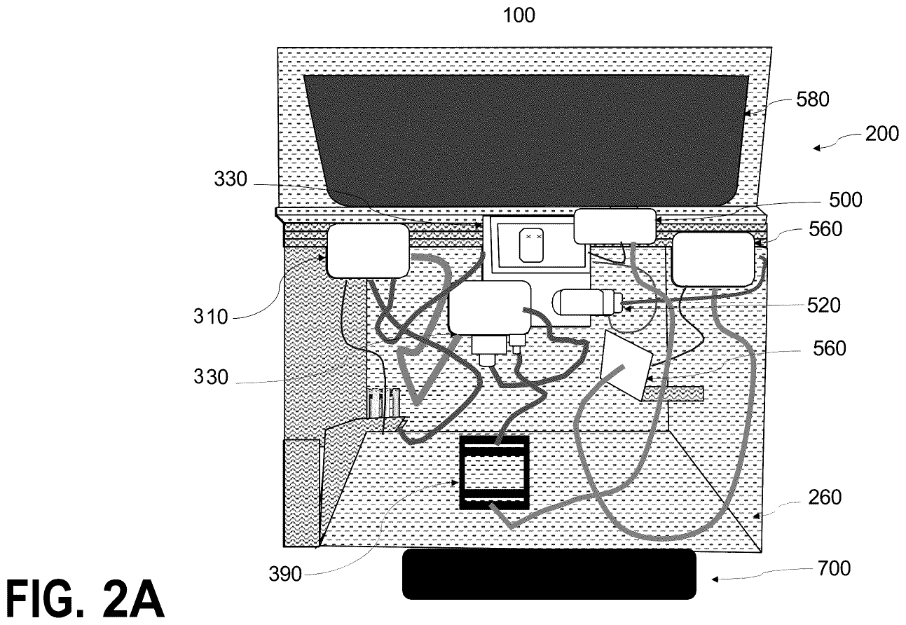

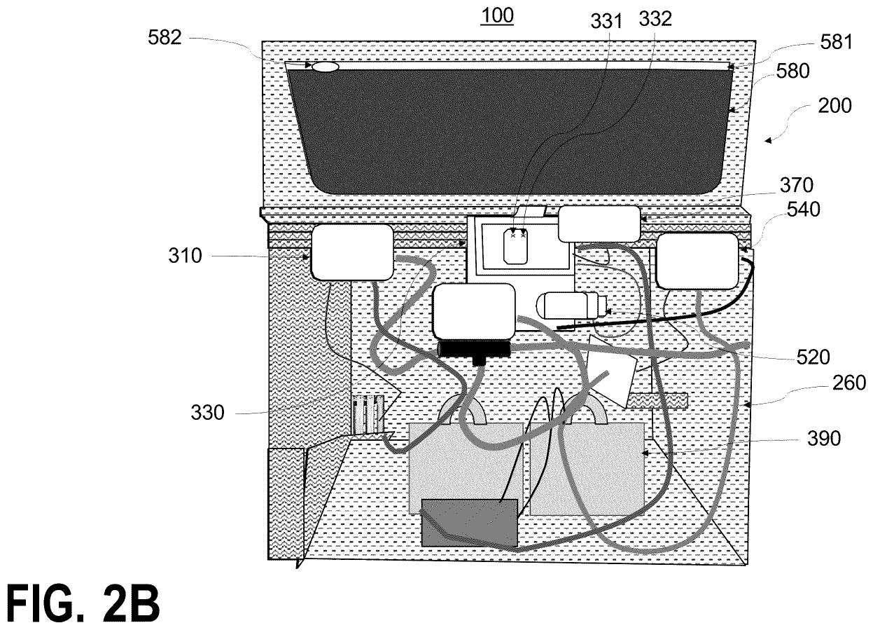

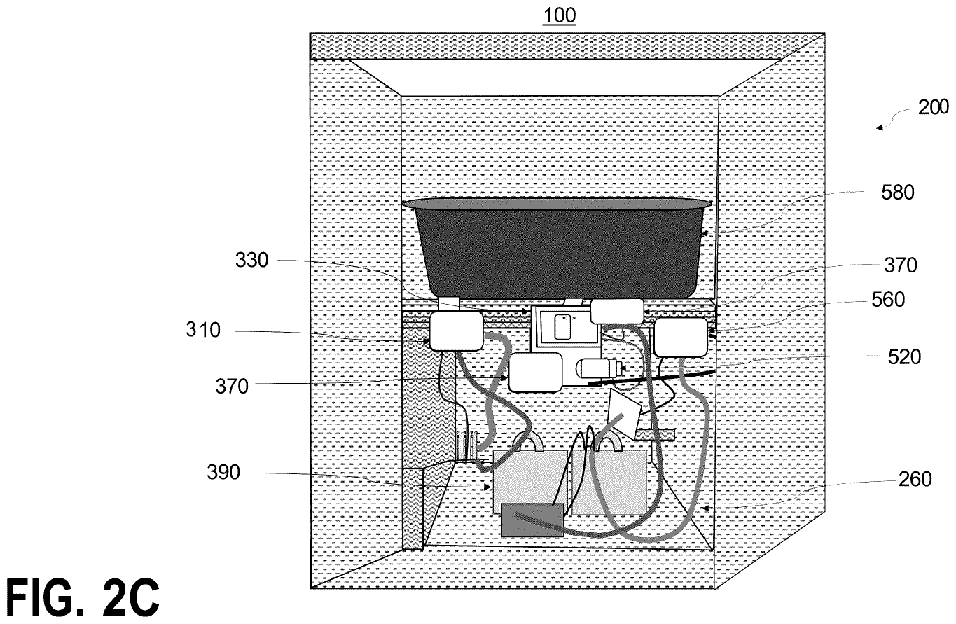

The structure 200 of the portable sanitizer apparatus 100 has a front 400 (shown in FIG. 1A), two sides 220, 230 (shown in FIG. 1B), a back 240 (shown in FIG. 1B), a top 250 (shown in FIG. 1B), a floor 260 (shown in FIG. 2) and an inside 300 (shown in FIG. 2).

In FIG. 1A, the front 400 of the structure 200 has a ledge 401, an upper portion 402 and a bottom portion 403. The bottom portion 403 has one or more first windows 404, 405, 406. A first of the first windows 404 of the bottom portion 403 has a sanitizer dispenser 408. Although the first of the first windows 404 is shown in the application having the sanitizer dispenser 408, one would easily recognize that more of the first window 404, 405, 406 may be implemented with a sanitizer dispenser 408 if desired.

In FIG. 18 has one or more drain plugs 416, 417 at a bottom 418 of the front 400 of the structure 200. The drain plugs 416, 417 being for releasing of liquid retained in the structure 200.

A second of the first windows 405 of the bottom portion 403 has a soap dispenser 409. Although only one first window 404 is shown in the application having the soap dispenser 409, one would easily recognize that more the second of the first window 405 may have additional soap dispensers 409 as may be desired and implemented. The soap dispensers 409 allow for a user to have soap when washing their hands.

A third of the first windows 406 of the bottom portion has a paper towel holder 410. Although only the third of the first window 406 is shown in the application as having a paper towel holder 410, one would easily recognize that more than one of the first windows 404, 405, 406 may have the paper towel holder 410 may be desired and implemented.

The upper portion 402 has one or more second windows 411. The first of the second windows 411 of the upper portion 402 is preferably configured to be near the ledge 401, however other placement of the first of the second windows 411 is hereby contemplated. The first of the second windows 411 has a water spicket 412.

The first windows 404, 405, 406 are preferably equally spaced along the the bottom 410 and are configured to be substantially near the ledge 401, however other placement of the second windows 404, 40, 406 are hereby contemplated.

In FIG. 1B, the back 240 is preferably open, thus access to the inside 260 is easily accessed for placement of equipment, as will be presented later in FIG. 2 in this application, or maintenance of the equipment. The back 240 further allows for ventilation for the equipment. Optionally, and/or additionally, the back 240 may have doors (not shown) however one of ordinary skill would understand how to place and install the doors onto the back 240 of the structure 200.

As one of ordinary skill would easily understand, the description of and of the second window 411 and the first windows 404, 405, 406 of the front 400 are optionally, and or additionally, similarly situated on either or both of the two sides 220, 230. In FIG. 1B, it is shown that the first window 411 and the water faucet 412, the sanitizer 410 of the first of the second windows 404 and the soap dispenser 409 of the third of the second windows 406 are shown on a first of the two sides 220. The front 400 is handicap accessible.

The two sides 220, 230, the top 250 and the floor 260 preferably have wooden or other type of wall panels. Optionally and/or additionally, the top 250 has a solar panel 251. The solar panel 251 is useful for collecting energy from a sun and converting the sun's energy into electrical energy for powering the portable sanitizer apparatus 100. The solar panel 251 is preferably a twenty (20) watt solar panel, however other types of solar panels are hereby contemplated, such as, but not limited to, off-the shelf solar panels.

The solar panel 251 is preferably eighteen and one-tenth (18.1) inches in width, however other widths are hereby contemplated, including, but not limited to, ten (10) inches, twenty (20) inches, etc. The solar panel 251 is preferably thirteen and eight-tenth (13.8) inches in length, however other lengths are hereby contemplated, including, but not limited to, fifteen (15) inches, twenty-four (24) inches, etc. The solar panel 251 is preferably one (1) inch in depth, however other depths are hereby contemplated, including, but not limited to, one-half (0.5) inch, two (2) inches, etc.

The ledge 401 has an inside 420 and a cover 421. The inside 420 of the ledge 401 is useful for storing supplies such as paper towels, soap, sanitizer, etc. The cover 421 can be open and closed. When open, the cover 421 allows for access to the inside 420 to store or retrieve supplies.

Referring now to FIG. 2A, FIG. 2B and FIG. 2C, illustrated embodiments of the inside 300 of the structure 200 of the portable sanitizer apparatus 100 as shown in FIG. 1A and FIG. 18 are presented.

The inside 300 of the structure 200 of the portable sanitizer apparatus 100 has a first control box 310, a solar battery charger 330, a water pump 370, one or more batteries 390, a hot water tank 500, a converter 520, a second control box 540, an second automatic faucet 560 and a tank 580.

The solar panel 251 of the top 250 of the structure 200 of the portable sanitizer apparatus 100 is coupled to the solar battery charger 330. The solar battery charger 330 is electrically coupled to the one or more batteries 390. The solar battery charger 330 has a first light 331 and a second light 332. The first light 331 preferably has a red/yellow color, however other colors are hereby contemplated. The first light 331 is illuminated when the solar battery charger 330 is receiving energy from the solar panel 251 and in the process of charging the batteries 390 utilizing converter 520. When the batteries 390 are fully charged, the first light 331 is unlit and the second light 332 is illuminated. The second light 332 is preferably a green color, however other colors are hereby contemplated. Further, when the batteries 390 are low on charge, then the first light 331 is illuminated in, preferably, the red color. The solar battery charger 330 is automatic, in that the solar battery charger 330 does not function when the solar panel 250 does not receive sunlight, such as at night, but will automatically restart when the solar panel 250 is receiving the sun's energy and sending the energy to the solar battery charger 330.

The hot water tank 500 is preferably installed vertically however it is hereby contemplated that the hot water tank 500 may be installed in any configuration such as horizontal, etc. The tank 580, which contains cold, clean water, is coupled to the hot water tank 500 to provide water for heating via an inlet pipe. An outlet water pipe (not shown) is coupled to the hot water tank 500, the outlet water pipe 501 is coupled to either or both the first automatic faucet 350 or the second automatic faucet 560 depending on the expected and engineering of the apparatus. The hot water tank 500 is electrically coupled to the batteries 390.

The hot water tank 500 is preferably black in color, however any other color may be used and is hereby contemplated by this application. The hot water tank 500 is preferably three-thousand watts (3000W) in power, however other power levels are hereby contemplated as desired. The hot water tank 500 is preferably an electric tankless instant hot water tank, such as the Garosa ASIN B07Q1CL1TP model, however other electric tankless instant hot water tanks may be used.

On a top 581 of the water tank 580 is a receiving port 582. The receiving port 582 of the water tank 580 is useful for providing water in the water tank 580 for use in the structure 200.

The water pump 370 is coupled to the hot water tank 500 and to either or both the first and second automatic faucet.

The control boxes 310, 540 have a solenoid (not shown), valve (not shown) and a battery (not shown). The control boxes 310, 540 each control at least one the functions of the portable sanitizer apparatus 100.

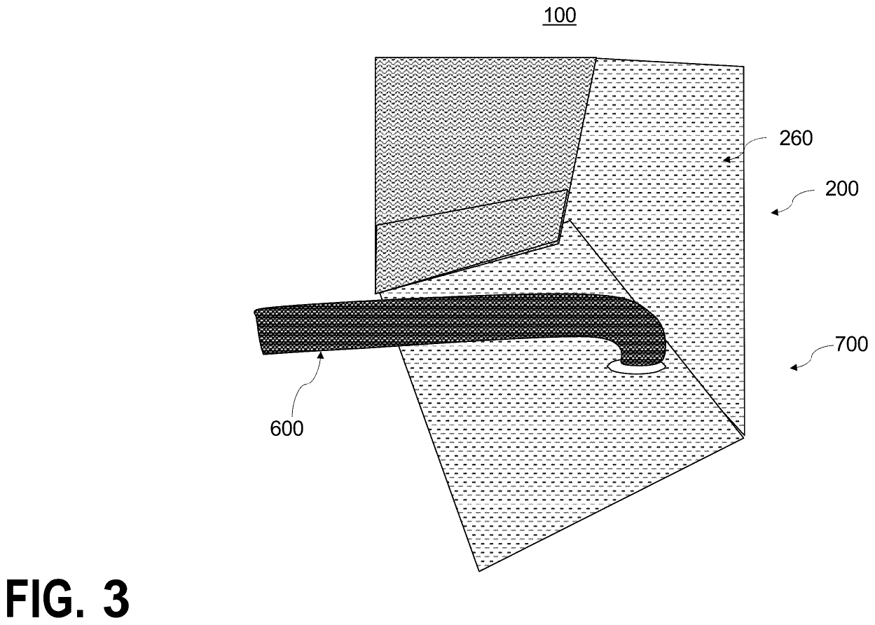

FIG. 3 has a faucet 600. The drain pipe is coupled to a drain (not shown) for disposal of waste water from the portable sanitizer apparatus 100. The faucet 600 is further coupled to a waste water tank 700. The waste water tank 700 being for disposing of the waste water and preventing contamination.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A portable sanitizer apparatus for helping to prevent the spread of disease, the apparatus comprising:
a structure, the structure having a top, a floor, two sides and a back, the back being open, and wherein the two sides having walls;
a front of the structure, the front comprising:
a ledge, the ledge having an inside and a cover, wherein the cover being for allowing access to the inside of the ledge, wherein the inside of the ledge being for storing supplies;
a lower portion, the lower portion having a plurality of first windows;
the one or more first windows for accessing one of: sanitizer, a soap dispenser and paper towels, wherein a top of the second windows being configured be in the lower portion significantly near the ledge; and
an upper portion, the upper portion having a second window; the second window having a water faucet, and wherein the second window of the upper portion being configured significantly near the ledge;
a solar panel, the solar panel being coupled to a top of the structure;
an inside, the inside comprising:
one or more batteries;
one or more solar battery chargers, each of the solar battery chargers being coupled to the solar panel and to a converter, wherein the converter for converting solar energy into electrical current, wherein the converter being coupled to the batteries, the solar battery charger having a first light and a second light;
a hot water tank, the hot water tank coupled to a tank for receiving cold water, the hot water tank being configured to heat the received cold water, the hot water tank having an outlet water pipe for releasing the hot water, wherein the hot water tank being coupled to the batteries;
a control box, the control box being coupled to the hot water tank, wherein the control box configured to control the outflow of hot water from the hot water tank;
a water pump, the water pump being coupled to the control box and the hot water tank, the water pump being configured to disperse hot water from the hot water tank; and
a drain pipe, the drain pipe being configured to receive waste water form the apparatus, the drain pipe being coupled to a drain in the floor of the structure and the drain being coupled to a waste water tank.

2. The apparatus of claim 1, wherein the control box further comprising:
a solenoid;
a valve; and
a battery.

3. The apparatus of claim 1, wherein the hot water tank being an electric tankless hot water tank.

4. The apparatus of claim 1, wherein the hot water tank being black in color.

5. The apparatus of claim 1, wherein the hot water tank having a power being three-thousand (3000) watts.

6. The apparatus of claim 1, wherein the hot water tank being configured in a vertical positioning.

7. The apparatus of claim 1, wherein the first light being a red/yellow light.

8. The apparatus of claim 1, wherein when the battery is being charged by the solar battery charger, then the first light being illuminated a yellow color.

9. The apparatus of claim 1, wherein the batteries are fully charged, the second light being illuminated a green color, and wherein the first light being unlit.

10. The apparatus of claim 1, wherein the batteries being low on charge, the first light being illuminated a red color.

11. The apparatus of claim 1, wherein the solar battery charger being automatic.

12. The apparatus of claim 1, wherein the solar panel having a length being eighteen and one-tenth (18.1) inches.

13. The apparatus of claim 1, wherein the solar panel having a width being thirteen and eight-tenths (13.8) inches.

14. The apparatus of claim 1, wherein the solar panel having a depth being one (1) inch.

15. The apparatus of claim 1, wherein at least one of the sides comprising:
a ledge;
a lower portion, the lower portion having a plurality of first windows;
the one or more first windows for accessing one of: sanitizer, a soap dispenser and paper towels, wherein a top of the second windows being configured be in the lower portion significantly near the ledge; and
an upper portion, the upper portion having a second window; the second window having a water faucet, and wherein the second window of the upper portion being configured significantly near the ledge.
